(19) United States
(12) Patent Application Publication
(10) Pub. No.: US 2026/0273509 A1
(43) Pub. Date: Sep. 17, 2026

(54) RESIN FOR EXTRACTING LITHIUM FROM LITHIUM PRECIPITATION MOTHER LIQUOR, AND PREPARATION METHOD AND APPLICATION THEREOF

(71) Applicant: XI'AN LANSHEN NEW MATERIAL TECHNOLOGY CO., LTD., Xi'an (CN)

(72) Inventors: Hao GAO, Xi'an (CN); Ang MEI, Xi'an (CN); Yun ZHANG, Xi'an (CN); Renshan ZHANG, Xi'an (CN); Nina ZHANG, Xi'an (CN); Tao TIAN, Xi'an (CN); Bingjie SUN, Xi'an (CN)

(21) Appl. No.: 19/387,520

(22) Filed: Nov. 12, 2025

(30) Foreign Application Priority Data
Mar. 13, 2025 (CN) 202510294591.6

(51) Int. Cl. B01J 20/289; B01J 20/26; B01J 20/32; B01J 20/34; C01D 15/00; C08F 8/12; C08F 8/30; C08F 8/40; C22B 3/24; C22B 3/42; C22B 26/12

(52) U.S. Cl. CPC B01J 20/289; B01J 20/265; B01J 20/321; B01J 20/3219; B01J 20/3248; B01J 20/3293; B01J 20/3475; C01D 15/00; C08F 8/12; C08F 8/30; C08F 8/40; C22B 3/24; C22B 3/42; C22B 26/12

(57) ABSTRACT

The present disclosure provides a resin for extracting lithium from lithium precipitation mother liquor, a preparation method and application thereof. The resin is an amino resin in which an amino functional group is substituted by at least one group (P) as shown below.

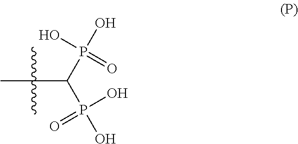 [SMILES: *C(P(=O)(O)O)P(=O)(O)O]

Where,

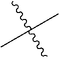

represents a chemical bond.

The resin provided by the present disclosure significantly enhances the absorption capacity for lithium ions under alkaline conditions and in the presence of high-concentration sodium ions. Using this resin, a high concentration of lithium ions can be obtained in the desorbed solution, making it suitable for extracting lithium ions from aqueous solutions, particularly from lithium-containing mother liquor and carbonate-type brine. The resin exhibits high commercial application potential. In addition, the preparation method of the resin disclosed by the disclosure is the one-pot synthesis method, featuring high reaction efficiency, stable synthesis, and simple operation, making it suitable for large-scale industrial production.

### CROSS-REFERENCE TO RELATED APPLICATION

This application claims the priority right of the prior patent application filed by the applicant with the National Intellectual Property Administration of the People's Republic of China on Mar. 13, 2025, with the application No. 202510294591.6 and the title “Resin for Lithium Extraction, and Preparation Method and Application Thereof”. The entire text of the said prior patent application is incorporated herein by reference.

### FIELD

The present disclosure relates to the field of lithium adsorbents, in particular to a resin for extracting lithium from lithium precipitation mother liquor, and a preparation method and application thereof.

### BACKGROUND ART

Lithium carbonate is one of the main raw materials for the production of lithium batteries. With the development of new energy electric vehicles, its market demand is increasing steadily. Among the methods employed for large-scale production of lithium carbonate, the precipitation method is the most widely used approach. Due to the low solubility of lithium carbonate, crude lithium carbonate can be obtained by precipitation when sodium carbonate is added to a lithium-rich solution, typically composed mainly of lithium chloride and sodium chloride. However, since this process takes place in a high-salinity environment, the precipitation yield is only around 80%, with approximately 20% of the lithium remaining in the mother liquor. This, in turn, can result in generation of a large amount of lithium-containing mother liquor.

The lithium-containing mother liquor is a multi-component aqueous salt system, with complex composition. Due to the preceding lithium enrichment process, ions such as K⁺, Mg²⁺, B (III), and SO₄²⁻ are present at relatively low concentrations, while the concentration of Li⁺ is relatively high (1.4-2.0 g/L). Meanwhile, a large amount of Na⁺ (55-62 g/L), along with Cl⁻ and CO₃²⁻, is also present. Therefore, the key to lithium recovery from the lithium-containing mother liquor lies in the separation of lithium and sodium. If the lithium-containing mother liquor is directly discharged back into the circulating system, it can only slightly increase the lithium content of the original brine, resulting in limited economic benefits. Therefore, it is of great importance to recover lithium from the lithium-containing mother liquor. Given the similar properties of lithium and sodium, lithium recovery becomes particularly challenging under conditions of a high sodium-to-lithium ratio. How to utilize the lithium-containing mother liquor economically and rationally has long remained as a technical challenge.

At present, the process for lithium recovery from lithium-containing mother liquor mainly includes membrane treatment, phosphate precipitation, solvent extraction, and absorption. Among them, membrane treatment faces challenges in industrial application due to the short service life of membranes and high costs. The phosphate precipitation method requires precise control of the pH value. Additionally, addition of sodium phosphate leads to increased cost, while the resulting lithium phosphate product has a lower market value than lithium carbonate, and the yield is also low, thus lacking economic advantages. In the solvent extraction method, the extraction efficiency varies significantly depending on the functional groups of the extractants; moreover, it is prone to emulsification, and the process involves procedures such as mixing, liquid separation, and back-extraction, making the operation relatively complex. For example, the Patent Publication No. CN116287777A discloses that phosphate esters can be used as lithium extractants in the comprehensive utilization method of lithium-containing mother liquor. The extractant belongs to a functionalized ionic liquid-based extraction system, in which the cation is a phosphate-ion-functionalized quaternary ammonium, and the anion is selected from the alkyl phosphates. However, ionic liquids are prone to loss during the extraction process, and the requirements for equipment are relatively high. For the absorption method, the types of adsorbents currently used in production mainly include: inorganic adsorbents (such as aluminum-based adsorbents, manganese-based ion sieve adsorbents, titanium-based ion sieve adsorbents, natural mineral adsorbents, and carbon material adsorbents); organic adsorbents (such as crown ether and calixarene-based adsorbents, ion-imprinted polymer adsorbents, layered metal acid salt adsorbents, porous foam-like adsorbents, and selective ion channel adsorbents). In recent years, the development of resin-based adsorbents has attracted significant attention. However, traditional organic ion-exchange resins exhibit low selectivity toward lithium ions. Such adsorbents often face difficulty in improving the absorption capacity while enhancing the selectivity. Moreover, the costs of raw materials and processes may still limit the industrial production.

### SUMMARY OF THE DISCLOSURE

To address the aforementioned problems, the present disclosure provides a resin, preferably a resin for lithium extraction, such as one for extracting lithium from lithium precipitation mother liquor. The resin is an amino resin in which an amino functional group is substituted by at least one group (P) as shown below:

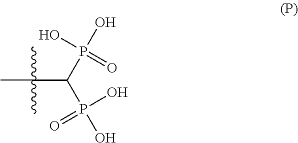 [SMILES: *C(P(=O)(O)O)P(=O)(O)O]

where,

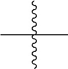

represents a chemical bond.

According to an embodiment of the present disclosure, the resin has a structure represented by Formula (I) below:

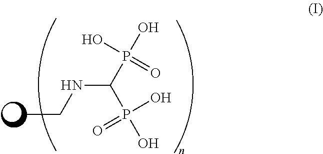

where,

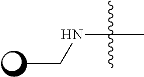 [SMILES: *NCC]

represents a group resulting from the substitution of a hydrogen atom on the amino group in the amino resin, and

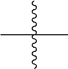

represents a chemical bond;

n represents an integer greater than 1.

According to an embodiment of the present disclosure, n is ≤ the total number of amino functional groups in the amino resin.

According to an embodiment of the present disclosure, the amino resin is an amino resin containing primary amine functional groups, which may also be referred to as a “primary amine resin”. For example, the amino resin includes, but is not limited to, polystyrene-based primary amine resin, polyvinyl chloride-based primary amine resin, and polyacrylamide-based primary amine resin.

According to an embodiment of the present disclosure, the resin is a resin for lithium extraction, such as one for extracting lithium from lithium precipitation mother liquor.

The present disclosure further provides a preparation method for the said resin, wherein the preparation method comprises the following steps:
(1) Reacting the amino resin represented by Formula (A) with phosphate esters and methylals to obtain a compound represented by Formula (B):

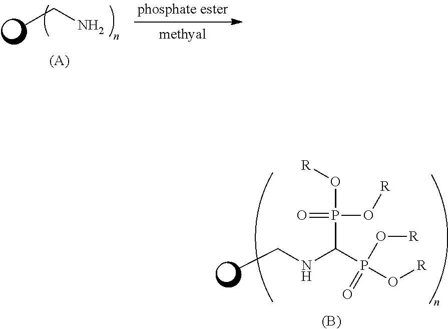

(2) Hydrolyzing the compound represented by Formula (B) to obtain the polymer represented by Formula (I):

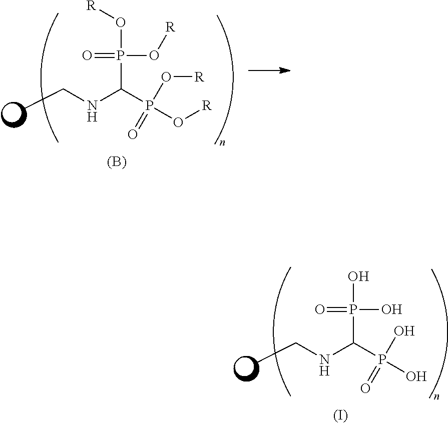

where, R is a linear or branched C₁₋₆ alkyl group;

The amino resin and n have the meaning as defined above.

According to an embodiment of the present disclosure, the C₁₋₆ alkyl group is a linear or branched saturated hydrocarbon group having 1, 2, 3, 4, 5, or 6 carbon atoms. The C₁₋₆ alkyl group may be linear or branched. For example, the C₁₋₆ alkyl group may be methyl, ethyl, propyl, isopropyl, butyl, isobutyl, tert-butyl, pentyl, hexyl, etc.

According to an embodiment of the present disclosure, the phosphate ester includes, but is not limited to, one, two or more selected from the group consisting of dialkyl phosphite (C₁₋₆), and tetra(C₁₋₆ alkyl)methylene diphosphate.

According to an embodiment of the present disclosure, the dialkyl phosphite (C₁₋₆) may be one, two or more selected from the group consisting of dimethyl phosphite, diethyl phosphite, triethyl phosphite, and diisopropyl phosphite.

According to an embodiment of the present disclosure, the tetra (C₁₋₆ alkyl)methylene diphosphate may be one, two or more selected from the group consisting of tetramethylmethylene diphosphate, tetraethylmethylene diphosphate, and tetraisopropylmethylene diphosphate.

According to an embodiment of the present disclosure, the orthoformate includes, but is not limited to, one, two or more selected from the group consisting of trialkyl orthoformates having C₁₋₆ alkyl groups, such as triethyl orthoformate, trimethyl orthoformate, and tributyl orthoformate.

According to an embodiment of the present disclosure, the reaction in the step (1) is performed using one-pot synthesis.

According to an embodiment of the present disclosure, in the step (1), the molar ratio of amino groups in the amino resin to the phosphate ester is 1:(2 to 4), such as 1:2, 1:2.5, 1:3, 1:3.5, or 1:4.

According to an embodiment of the present disclosure, in the step (1), the molar ratio of the amino resin to the orthoformate is 1:(1 to 2), such as 1:1, 1:1.5, or 1:2.

According to an embodiment of the present disclosure, the step (1) may be carried out under heating conditions. For example, the reaction temperature in the step (1) is within 125° C.-135° C.

According to an embodiment of the present disclosure, in the step (1), the reaction may last for 2 h-4h.

According to an embodiment of the present disclosure, in the step (1), after the reaction is completed, the reaction mixture is filtered, and the resulting solid product is rinsed for use in the next reaction step. As an example, the rinsing process involves alternating rinsing with ethanol and water, for instance, alternating rinsing for 3 times.

According to an embodiment of the present disclosure, in the step (2), the hydrolysis is carried out under acidic conditions.

According to an embodiment of the present disclosure, in the step (2), the hydrolysis is carried out in the presence of an acidic medium.

According to an embodiment of the present disclosure, in the step (2), the hydrolysis is carried out in the aqueous solution of acid. For example, the acid includes, but is not limited to, one, two or more inorganic acids selected from hydrochloric acid, sulfuric acid, and hydrobromic acid. In one embodiment, the concentration of the aqueous solution of hydrochloric acids or hydrobromic acids may be from 4 to 8 mol/L, and that of the aqueous solution of sulfuric acid may be from 2 to 4 mol/L.

According to an embodiment of the present disclosure, the step (2) may be carried out under heating conditions. For example, the reaction temperature in the step (2) is from 80° C. to 85° C.

According to an embodiment of the present disclosure, in the step (2), the reaction may last for 12 h-16h.

The present disclosure further provides a method for adsorbing lithium ions, comprising contacting the resin of the present disclosure with an aqueous solution containing lithium ions.

The present disclosure further provides the use of the resin of the present disclosure, wherein the resign is used for adsorbing lithium ions, for example, adsorbing lithium ions from an aqueous solution containing lithium ions.

According to an embodiment of the present disclosure, the method for adsorbing lithium ions comprises the following steps, or, the method of using resin for adsorbing lithium ions comprises the following steps:

Resin pretreatment: Taking a chromatography column, and packing it with the resin of the present disclosure, and passing pure water, an acidic solution, pure water, an alkaline solution, and pure water through the column in sequence;
Absorption: passing an aqueous solution containing lithium ions through the chromatography column;
Displacement: rinsing the chromatography column with pure water after absorption;
Desorption: eluting the column with an acidic solution and collecting the eluate;
Preferably, the method for adsorbing lithium ions comprises the following steps, or the use of using resin for adsorbing lithium ions comprises the following steps:
Chromatography column packing: packing the resin of the present disclosure into a chromatography column, such as one with a height-to-diameter ratio of 5 to 20;

According to an embodiment of the present disclosure, the resin pretreatment comprises the following steps: a chromatography column is provided and packed with the resin of the present disclosure. Preferably, the resin is first rinsed with 2BV pure water, followed by 2BV to 4BV an acidic solution (e.g. with a hydrogen ion concentration of 1-3 mol/L) at a flow rate of 0.5 to 2BV/h. The column is then rinsed with pure water until the pH value of the effluent is between 5 and 7. Subsequently, 2BV to 4BV of alkaline aqueous solution (e.g. with a hydroxide ion concentration of 1 to 3 mol/L) is passed through the column at a flow rate of 0.5 to 2BV/h, and finally, the column is rinsed with pure water until the pH value of the effluent reaches 7 to 10. According to an embodiment of the present disclosure, the resin pretreatment comprises the following steps: first, the resin is rinsed with 2BV pure water; subsequently, 3BV hydrochloric acid (1.5 mol/L) is passed through the column at a flow rate of 2BV/h; the column is then rinsed with pure water until the pH value of the effluent is between 5 and 7; finally, 4BV aqueous solution of sodium hydroxide (1.5 mol/L) passes through the column at a flow rate of 2BV/h, followed by rinsing with pure water until the value pH of the effluent reaches 7-10.

According to an embodiment of the present disclosure, in the absorption process, depending on the lithium concentration in the brine, 0.5-200BV lithium-containing aqueous solution may be passed through the chromatography column at a flow rate of 0.5 to 10BV/h. For example, when treating lithium-containing mother liquor, 0.5-10BV lithium-containing aqueous solution may be passed through the chromatography column at a flow rate of 0.5-2BV/h.

According to an embodiment of the present disclosure, the lithium-containing aqueous solution (also referred to as “lithium-containing water sample”) may be selected from, for example, natural salt lake brine containing lithium ions, concentrated natural salt lake brine, lithium-containing mother liquor, or other artificial or natural water samples containing lithium ions.

According to an embodiment of the present disclosure, the lithium-containing mother liquor may be the mother liquor obtained after lithium salt is precipitated in the lithium extraction process.

According to an embodiment of the present disclosure, the lithium-containing aqueous solution may comprise lithium ions as well as other metal cations. The other metal cations may be one or more selected from sodium ions and potassium ions.

According to an embodiment of the present disclosure, the lithium-containing aqueous solution may further comprise one or more anions, such as chloride, carbonate, bicarbonate, sulfate, and borate.

As an example, the lithium-containing aqueous solution may comprise Li⁺, Na⁺, and one, two, three, four, five, or six selected from the group consisting of CO₃²⁻, HCO₃⁻, K⁺, Cl, ⁻B(III), and SO₄²⁻.

According to an embodiment of the present disclosure, the lithium-containing aqueous solution further comprises H⁺ and OH⁻.

According to an embodiment of the present disclosure, no particular limitation is specified for the pH value of the lithium-containing aqueous solution, and it may vary within the range of 1 to 14. Preferably, the lithium-containing aqueous solution is neutral or alkaline, and the pH value may be from 6 to 10.

According to an embodiment of the present disclosure, in the displacement step, the chromatography column after absorption is rinsed with pure water at a flow rate of 2BV/h until the pH value of the effluent is between 7 and 10;

According to an embodiment of the present disclosure, in the desorption step, an acidic solution (for example, an acidic aqueous solution having a hydrogen ion concentration of 1.5-3 mol/L, such as hydrochloric acid with a hydrogen ion concentration of 1.5-3 mol/L) is passed through he column at a flow rate of 0.5 to 1BV/h, and the desorption solution is retained every 0.5-1BV.

According to an embodiment of the present disclosure, the method for adsorbing lithium ions or the use of using resin for adsorbing lithium ions further comprises resin regeneration and a lithium recovery.

According to an embodiment of the present disclosure, the resin regeneration step comprises rinsing with pure water at a flow rate of 2BV/h until the pH value of the effluent is between 5 and 7; then, passing 2-4BV alkaline aqueous solution (for example, a solution having a hydroxide ion concentration of 1.5 to 3 mol/L) through the column at a flow rate of 0.5 to 2BV/h, followed by rinsing with pure water until the pH value of the effluent is between 7 and 10.

According to an embodiment of the present disclosure, the lithium recovery step comprises: prior to adsorbing lithium from the lithium-containing mother liquor, passing the column effluent from the previous absorption cycle through the regenerated resin bed at a flow rate of 1 to 4BV/h, in order to fully recover the lithium.

### Beneficial Effects

The present disclosure relates to a resin with excellent selective absorption performance for lithium ions. The resin significantly enhances the absorption capacity for lithium ions under alkaline conditions and in the presence of high-concentration sodium ions. By using the resin, the desorbed solution with a high lithium ion concentration can be obtained, making it suitable for adsorbing lithium ions from lithium-containing aqueous solutions, particularly from lithium-containing mother liquor and carbonate-type brines, thereby providing high commercial application value. In addition, the resin of the present disclosure is prepared by the one-pot synthesis method, which offers high reaction efficiency, stable synthesis, and simple operation, making it suitable for large-scale industrial production.

### DETAILED DESCRIPTION

The present disclosure is further illustrated below with reference to specific embodiments. It should be understood that these embodiments are provided only for illustrative purposes and are not intended to limit the scope of the present disclosure. In addition, it should be understood that, after reading the descriptions contained in the present disclosure, various modifications or changes may be made to the disclosure, and such equivalent forms shall also fall within the scope defined by the appended claims.

Preparation Example 1: Synthesis of Primary Amine Resin 381 g of styrene, 38 g of 63% divinylbenzene, 210 g of liquid paraffin, and 4.3 g of benzoyl peroxide were mixed in a 1 L beaker and set aside; Aqueous phase: 2.5 L of water was added to a 5 L three-necked flask, followed by 1.3 g of carboxymethyl cellulose, 1.2 g of gelatin, and 2 mL of 4% methylene blue solution. The mixture was stirred and heated to 40° C. and kept for use. The prepared oil phase was then poured into the 5 L three-necked flask and allowed to stand for 10 minutes. Subsequently, stirring was started to uniformly disperse the oil phase into spherical beads. The temperature was raised to 70° C. and maintained for 2 hours, then increased to 85° C. over 2 hours and maintained for 3 hours, and finally raised to 90° C. over 2 hours and maintained for another 2 hours. After that, the reaction mixture was cooled down, and the resin was separated from the mixture and rinsed with water. The resin was then extracted with methylal, rinsed again with water, dried, and sieved to obtain polymer beads with a particle size of 0.3-1.5 mm.

335 g of the polymer beads obtained in the previous step were added to a dried 5 L reactor, followed by the addition of 1300 g of dichloroethane, 400 g of acetic anhydride, 500 g of N-hydroxymethylphthalimide, and 500 g of concentrated sulfuric acid. The mixture was stirred and heated to reflux for 10 hours. After cooling, the resulting beads were filtered, rinsed with methylal, and then rinsed with water to obtain spherical amide.

The spherical amide obtained in the previous step were added to a high-pressure reactor, followed by the addition of a 30% sodium hydroxide solution in an amount 1.5 times the mass of the beads. Then, the mixture was heated to 170° C. and reacted for 10 hours. After cooling, the mixture was filtered and rinsed with water to obtain the primary amine resin.

In accordance with the China National Standard GB/T 5760-2000 Determination for Exchange Capacity of Anion Exchange Resins in Hydroxide Form, a sample of the obtained primary amine resin was taken to determine its weak base exchange capacity. The content of the primary amine functional groups was 7.2 mmol/g dry resin (numerically equivalent to the weak base exchange capacity). The wet primary amine resin obtained through water rinsing was mixed with methanol at a volume ratio of 1:1.5 in a three-necked flask and stirred for 1 hour. Stirring was then stopped, and the methanol was removed by filtration. After the methanol is rinsed three times using this method, the resin was then dried to obtain dry primary amine resin, which was used in the following embodiments and comparative examples.

### Embodiment 1

50 g of dry primary amine resin, 107 g of triethyl orthoformate, and 199 g of diethyl phosphite were sequentially added to a 1 L three-necked flask and stirred. Then, the mixture was gradually heated to 135° C. and reacted for 2 hours. After the reaction was completed, the reaction solution in the flask was removed by filtration. Subsequently, 300 mL of ethanol was added to the flask and stirred for 30 minutes. Stirring was stopped, and the ethanol was removed by filtration. Further, 300 mL of pure water was added, stirred for another 30 minutes, and then removed by filtration. The resin was rinsed three times using this method to obtain a resin.

The obtained resin was then placed in 250 mL of hydrochloric acid (6 mol/L) for hydrolysis, and the reaction was conducted at 80° C. for 14 hours. After the reaction was completed, the reaction mixture was suction-filtered and rinsed with water to obtain the resin sample 1.

### Embodiment 2

50 g of dry primary amine resin, 80 g of triethyl orthoformate, and 199 g of diethyl phosphite were sequentially added to a 1 L three-necked flask and stirred. The mixture was gradually heated to 130° C. and reacted for 3 hours. After the reaction was completed, the reaction solution in the flask was removed by filtration. Then, 300 mL of ethanol was added to the flask and stirred for 30 minutes. Stirring was stopped, and the ethanol was removed by filtration. Subsequently, 300 mL of pure water was added, stirred for another 30 minutes, and then removed by filtration. This rinsing procedure was repeated three times to obtain a resin.

The obtained resin was then placed in 250 mL of hydrobromic acid (5 mol/L) for hydrolysis, and the reaction was conducted at 82° C. for 12 hours. After the reaction was completed, the reaction mixture was suction-filtered and rinsed with water to obtain the resin sample 2.

### Embodiment 3

50 g of dry primary amine resin, 107 g of triethyl orthoformate, and 149 g of diethyl phosphite were sequentially added to a 1 L three-necked flask and stirred. The mixture was gradually heated to 135° C. and reacted for 4 hours. After the reaction was completed, the reaction solution in the flask was removed by filtration. Then, 300 mL of ethanol was added to the flask and stirred for 30 minutes. Stirring was stopped, and the ethanol was removed by filtration. Subsequently, 300 mL of pure water was added, stirred for another 30 minutes, and then removed by filtration. This rinsing procedure was repeated three times to obtain a resin.

The obtained resin was then placed in 250 mL of hydrochloric acid (4 mol/L) for hydrolysis, the reaction was conducted at 85° C. for 16 hours. After the reaction was completed, the reaction mixture was suction-filtered and rinsed with water to obtain the resin sample 3.

### Embodiment 4

50 g of dry primary amine resin, 80 g of triethyl orthoformate, and 149 g of diethyl phosphite were sequentially added to a 1 L three-necked flask and stirred. The mixture was gradually heated to 130° C. and reacted for 2 hours. After the reaction was completed, the reaction solution in the flask was removed by filtration. Then, 300 mL of ethanol was added to the flask and stirred for 30 minutes. Stirring was stopped, and the ethanol was removed by filtration. Subsequently, 300 mL of pure water was added, stirred for another 30 minutes, and then removed by filtration. This rinsing procedure was repeated three times to obtain a resin.

The obtained resin was then placed in 250 mL of sulfuric acid (4 mol/L) for hydrolysis, the reaction was conducted at 80° C. for 15 hours. After the reaction was completed, the reaction mixture was suction-filtered and rinsed with water to obtain the resin sample 4.

### Embodiment 5

50 g of dry primary amine resin, 53 g of trimethyl orthoformate, and 99 g of diethyl phosphite were sequentially added to a 1 L three-necked flask and stirred. The mixture was gradually heated to 125° C. and reacted for 4 hours. After the reaction was completed, the reaction solution in the flask was removed by filtration. Then, 300 mL of ethanol was added to the flask and stirred for 30 minutes. Stirring was stopped, and the ethanol was removed by filtration. Subsequently, 300 mL of pure water was added, stirred for another 30 minutes, and then removed by filtration. This rinsing procedure was repeated three times to obtain a resin.

The obtained resin was then placed in 250 mL of sulfuric acid (2 mol/L) for hydrolysis at 85° C. for 13 hours. After the reaction was completed, the reaction mixture was vacuum filtered and rinsed with water to obtain the resin sample 5.

### Comparative Example 1

50 g of dry primary amine resin and 150 mL of methanol were added to a 1 L three-necked flask and stirred for 2 hours. Then, stirring was then stopped, and the methanol was removed by filtration. Subsequently, 150 mL of pure water was added and stirred for 1 hour. Stirring was stopped, and the liquid was removed by filtration. After rinsing with water for three times, 170 g of hydrochloric acid (36 wt %) and 118 g of phosphorous acid were added to the resin. The mixture was stirred and gradually heated to 65° C. Then, 120 g of formaldehyde solution (37 wt %) was added dropwise to the reaction mixture. After the addition was completed, the mixture was further heated to 95° C. and maintained at that temperature for 8 hours, thus to complete the reaction. After the reaction, the mixture was cooled to the room temperature. The reaction solution was removed by filtration. Then, 300 mL of pure water was added to the flask and stirred for 30 minutes. Stirring was stopped, and the water was removed by filtration. This rinsing procedure was repeated three times to obtain the resin sample D1.

### Comparative Example 2

50 g of dry primary amine resin and 150 mL of methanol were added to a 1 L three-necked flask and stirred for 2 hours. Stirring was then stopped, and the methanol was removed by filtration. Subsequently, 150 mL of pure water was added and stirred for 1 hour. Stirring was stopped, and the liquid was removed by filtration. After rinsing with water for three times, 170 g of hydrochloric acid (36 wt %) and 59 g of phosphorous acid were added to the resin. The mixture was stirred and gradually heated to 65° C. Then, 60 g of formaldehyde solution (37 wt %) was added dropwise to the reaction mixture. After the addition was completed, the mixture was further heated to 95° C. and maintained at that temperature for 8 hours.

After the reaction was completed, the mixture was cooled to the room temperature. The reaction solution was removed by filtration. Then, 300 mL of pure water was added to the flask and stirred for 30 minutes. Then, stirring was stopped, and the water was removed by filtration. This rinsing procedure was repeated three times to obtain resin sample D2.

The resin samples obtained in embodiments 1 to 5 have the structure represented by Formula (1), while the resin samples obtained in Comparative Examples 1 and 2 have the structure represented by Formula (2):

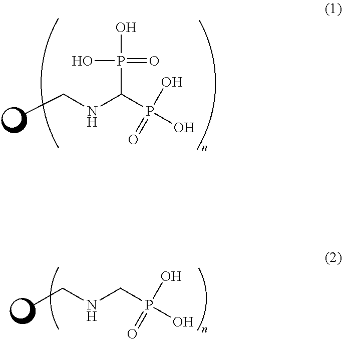

### Application Examples

### 1. Resin Pretreatment

A glass chromatography column was taken and packed with 60 mL (1BV) of the resin sample prepared in one of the above embodiments or comparative examples. First, the resin was rinsed with 2BV of pure water, and then 3BV of hydrochloric acid (1.5 mol/L) was passed through the column at a flow rate of 2BV/h. Later, the column was rinsed with pure water until the pH value of the effluent was between 5 and 7. Finally, 4BV of sodium hydroxide aqueous solution (1.5 mol/L) was passed through the column at a flow rate of 2BV/h, and then rinsed with pure water until the pH value of the effluent was between 7 and 10.

### 2. Resin Absorption and Desorption

2.1 Lithium Extraction from Resin

Absorption: 10BV of a lithium-containing mother liquor sample (with its composition shown in Table 1) was passed through the chromatography column at a flow rate of 2BV/h. The effluent mixture sample was taken to determine the lithium concentration.

Displacement: The column was rinsed with 4BV of pure water at a flow rate of 2BV/h.

Desorption: 3BV of hydrochloric acid (1.5 mol/L) was passed through the column at a flow rate of 1BV/h. A mixed sample was taken every 0.5BV to determine the concentrations of lithium and sodium in the desorbed solution.

### 2.2 Resin Regeneration

The eluate was rinsed with 4BV of pure water at a flow rate of 2BV/h until its pH value was between 5 and 7. Then, 4BV of sodium hydroxide aqueous solution (1.5 mol/L) was passed through the column at a flow rate of 2BV/h, and then rinsed with pure water until the pH value of the effluent was between 7 and 10.

In practical applications, prior to adsorbing lithium from the lithium-containing mother liquor, the column effluent from the previous absorption cycle may be passed through the regenerated resin bed at a flow rate of 1 to 4BV/h to fully recover lithium.

$$adsorbtion capacity ( mg / ml ) = \frac{\begin{matrix}effluent volume ( L ) * [ initial concentration ( mg / L ) - \\ residual concentration ( mg / L ) ]\end{matrix}}{volume of adsorbent ( mL )}$$

TABLE 1
Information of Lithium-Containing Mother
Liquor Before Column Absorption

| | Lithium-Containing Mother Liquor | | | | | | | |
|---|---|---|---|---|---|---|---|---|
| | Li⁺ | Na⁺ | CO₃²⁻ | K⁺ | Cl⁻ | B (III) | SO₄²⁻ | pH |
| Units g/L | 1.401 | 62.08 | 17.05 | 0.545 | 74.01 | 0.455 | 7.6 | 14 |

The resin samples obtained from the above embodiments and comparative examples were used for lithium-sodium separation. The product performance and absorption effluent data are shown in Table 2 below:

TABLE 2
Lithium Content and Absorption Amount of Lithium
Resin in the Effluent after Resin Absorption

| Sample Name | Li⁺(g/L) | Absorption Capacity(mg/mL) |
|---|---|---|
| Resin sample 1 | 0.25 | 11.5 |
| Resin Sample 2 | 0.36 | 10.4 |
| Resin Sample 3 | 0.46 | 9.4 |
| Resin Sample 4 | 0.51 | 8.9 |
| Resin Sample 5 | 0.59 | 8.1 |
| Resin Sample D1 | 0.96 | 4.4 |
| Resin Sample D2 | 0.98 | 4.2 |

Desorption tests are conducted according to the desorption procedure, and the results are shown in Table 3:

TABLE 3
Desorption Performance of Resin

| | Desorption | | |
|---|---|---|---|
| | Volume/BV | Li⁺ (g/L) | Na⁺ (g/L) |
| Resin Sample 1 | 0.5 | 0.41 | 1.21 |
| | 1 | 1.78 | 12.50 |
| | 1.5 | 2.68 | 14.53 |
| | 2 | 6.58 | 8.69 |
| | 2.5 | 7.86 | 4.35 |
| | 3 | 0.15 | 0.03 |
| Resin Sample 2 | 0.5 | 0.38 | 1.15 |
| | 1 | 1.56 | 11.27 |
| | 1.5 | 2.35 | 13.01 |
| | 2 | 6.21 | 8.26 |
| | 2.5 | 7.48 | 4.09 |
| | 3 | 0.12 | 0.15 |
| Resin Sample 3 | 0.5 | 0.34 | 1.04 |
| | 1 | 1.41 | 10.18 |
| | 1.5 | 2.12 | 11.75 |
| | 2 | 5.60 | 7.46 |
| | 2.5 | 6.75 | 3.69 |
| | 3 | 0.11 | 0.14 |
| Resin Sample 4 | 0.5 | 0.32 | 0.95 |
| | 1 | 1.37 | 9.80 |
| | 1.5 | 2.06 | 11.39 |
| | 2 | 5.07 | 6.81 |
| | 2.5 | 6.05 | 3.41 |
| | 3 | 0.12 | 0.10 |
| Resin Sample 5 | 0.5 | 0.29 | 0.83 |
| | 1 | 1.25 | 8.55 |
| | 1.5 | 1.89 | 9.94 |
| | 2 | 4.63 | 5.94 |
| | 2.5 | 5.53 | 2.98 |
| | 3 | 0.11 | 0.09 |
| Resin Sample D1 | 0.5 | 0.18 | 0.59 |
| | 1 | 0.77 | 5.23 |
| | 1.5 | 1.15 | 7.55 |
| | 2 | 2.83 | 4.56 |
| | 2.5 | 3.38 | 2.13 |
| | 3 | 0.09 | 0.06 |
| Resin Sample D2 | 0.5 | 0.17 | 0.56 |
| | 1 | 0.73 | 5.32 |
| | 1.5 | 1.10 | 7.68 |
| | 2 | 2.70 | 4.15 |
| | 2.5 | 3.22 | 1.78 |
| | 3 | 0.08 | 0.04 |

According to the data in Tables 2 and 3, the resin samples obtained in embodiments 1 to 5 exhibited significantly higher lithium absorption capacity compared to those in comparative examples 1 and 2, with the lithium absorption capacity increased by more than 1.8 times.

Moreover, when the mixed effluent collected from 1.5-2.0BV and 2.0-2.5BV segments was combined to serve as the qualified product solution, the sodium-to-lithium ratio of the product solution using the resin samples from embodiments 1 to 5 was significantly decreased as compared to that of the lithium-containing mother liquor before column chromatography. In addition, the sodium-to-lithium ratio was also superior to that of the product solution obtained using the resin samples from comparative examples 1 and 2, indicating a better lithium-sodium separation performance.

Furthermore, the product solution obtained using the resin samples from embodiments 1 to 5 not only exhibits improved lithium selectivity but also contains a significantly higher lithium concentration than that obtained using the comparative resin samples.

Moreover, the resin synthesis process of the present disclosure is more convenient. A product with superior performance can be obtained via one-pot reaction, demonstrating broad prospects for industrial application.

The embodiments of the present disclosure have been described above by way of illustration. It should be understood that the scope of protection of the present disclosure is not limited to such illustrative embodiments. Any modifications, equivalent substitutions, improvements, etc. made in the art within the spirit and scope of the present disclosure shall fall within the scope of protection defined by the claims of this application.

What is claimed is:

1. A resin, characterized in that, the resin is an amino resin in which an amino functional group is substituted by at least one group (P) as shown below: 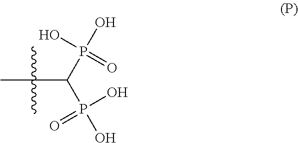 [SMILES: *C(P(=O)(O)O)P(=O)(O)O]
where 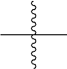
represents a chemical bond.

2. The resin according to claim 1, wherein the resin has a structure represented by Formula (I): 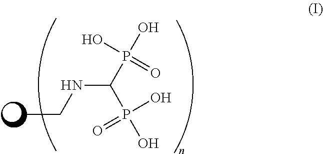
where, 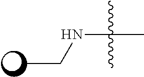 [SMILES: *NCC]
represents a group resulting from substitution of a hydrogen atom on an amino group of the amino resin, 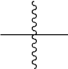
represents a chemical bond;
n represents an integer greater than 1.

3. The resin according to claim 2, wherein n is less than or equal to the total number of amino functional groups in the amino resin.

4. The resin according to claim 1, wherein the amino resin is an amino resin containing primary amine functional groups.

5. The preparation method of the resin according to claim 1, comprising the following steps:
(1) Reacting the amino resin represented by Formula (A) with a phosphate ester and an orthoformate to obtain a compound represented by Formula (B): 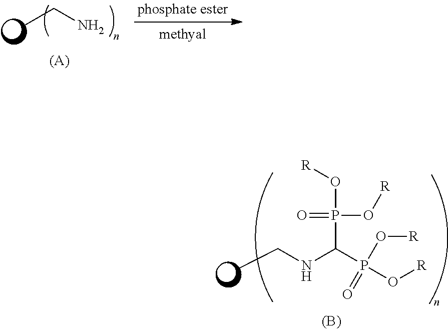
(2) Hydrolyzing the compound represented by Formula (B) to obtain a polymer represented by Formula (I): 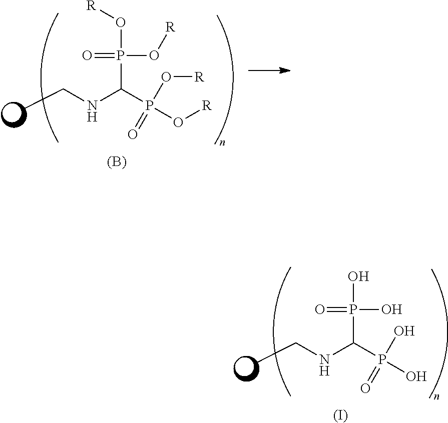
Where, R is a linear or branched C₁₋₆ alkyl group;
n represents an integer greater than 1.

6. The method according to claim 5, wherein the phosphate ester is selected from the group consisting of dialkyl phosphites having C₁₋₆ alkyl groups and tetra(C₁₋₆ alkyl)methylene diphosphates, either alone or in combination.

7. The method according to claim 5, wherein the reaction in step (1) is carried out as a one-pot reaction.

8. The method according to claim 7, wherein:
in step (1), the molar ratio of amino groups in the amino resin to the phosphate ester is 1:(2-4); or
in step (1), the molar ratio of the amino resin to the orthoformate is 1:(1-2); or
in step (2), the hydrolysis is carried out under acidic conditions.

9. A method for adsorbing lithium ions, comprising contacting the resin according to claim 1 with an aqueous solution containing lithium ions.

10. The method according to claim 9, wherein the method comprises the following steps:
Resin pretreatment: packing a chromatography column with the resin, and sequentially passing pure water, an acidic solution, pure water, an alkaline solution, and pure water through the column;
Absorption: passing an aqueous solution containing lithium ions through the chromatography column;
Rinsing: rinsing the column with pure water after absorption;
Desorption: passing an acidic solution through the column and collecting the effluent;
Optionally, the method further comprises a resin regeneration step and a lithium recovery step.

11. The use of the resin according to claim 1 for adsorbing lithium ions.

12. The use according to claim 11, wherein the resin is used for adsorbing lithium ions from an aqueous solution containing lithium ions.

13. The use according to claim 12, wherein the aqueous solution containing lithium ions is selected from natural salt lake brine containing lithium ions, concentrated natural salt lake brine, lithium-containing mother liquor, or other artificial or natural water samples containing lithium ions.
